(19) United States
(12) Patent Application Publication
(10) Pub. No.: US 2012/0022790 A1
(43) Pub. Date: Jan. 26, 2012

(54) TOPOGRAPHY RECORDING TECHNIQUES

(75) Inventors: Quan YUAN, Beijing (CN); Haipeng GUO, Beijing (CN); Dong HOU, Beijing (CN)

(73) Assignee: EMPIRE TECHNOLOGY DEVELOPMENT LLC, Wilmington, DE (US)

(21) Appl. No.: 12/841,020

(22) Filed: Jul. 21, 2010

(51) Int. Cl. G06F 19/00

(52) U.S. Cl. 702/5

(57) ABSTRACT

Techniques for topography recording are provided. In at least some implementations, a topography recording device includes a position determination unit configured to obtain coordinate data of a location; a sensor unit configured to determine the inclination of terrain at the location; a processing unit coupled to the position determination unit and the sensor unit, and configured to calculate the gradient of the terrain at the location based on the inclination of the terrain at the location, and to generate a map indicating three-dimensional terrain in the vicinity of the location based on the coordinate data of the location and the gradient of the terrain at the location.

### TECHNICAL FIELD

The present disclosure is generally related to topology recording.

### BACKGROUND

Outdoor adventure, such as mountaineering and hiking, are fast growing in popularity. However, those with a penchant for such outdoor adventure may find themselves with a need to adequately analyze the surrounding terrain and/or retrace his or her steps. By way of example, a hiker may encounter a storm or suffer an accident while on a hike. Conventional devises, such as global positioning system (GPS) devices, are capable of only providing current location or position information and, as such, are not useful in allowing its user to analyze the surrounding terrain and/or retrace his or her steps in the case of an emergency.

### SUMMARY

By way of example, but not a limitation, one embodiment of the present disclosure provides a topography recording device, which includes: a position determination unit configured to obtain coordinate data of a location; a sensor unit configured to determine inclination of the terrain at the location; a processing unit coupled to the position determination unit and the sensor unit, and configured to calculate gradient of the terrain at the location based on the data representing inclination of the terrain at the location, and to generate a map showing three-dimensional terrain in the vicinity of the location based on the coordinate data of the location and the gradient of the terrain at the location.

By way of example, but not a limitation, another embodiment of the present disclosure provides a topography recording method including: obtaining coordinate data of a location; determining inclination of the terrain at the location; calculating gradient of the terrain at the location based on data representing inclination of the terrain at the location; and generating a map showing three-dimensional terrain of the location based on the coordinate data of the location and the gradient of the terrain at the location.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a block diagram of a topography recording device according to an illustrative embodiment of the present disclosure;

FIG. 2 shows a schematic view of a technique for determining inclination of terrain and calculating the slope gradient of the terrain by a sensor unit according to an illustrative embodiment of the present disclosure;

FIG. 3 shows a block diagram of a topography recording device according to another illustrative embodiment of the present disclosure; and

FIG. 4 shows a flow chart of processes for recording topography data according to an illustrative embodiment of the present disclosure.

### DETAILED DESCRIPTION

In the following detailed description, reference is made to the accompanying drawings, which form a part hereof. In the drawings, similar symbols typically identify similar components, unless context indicates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to techniques, devices and methods related to topography recording. For example, in accordance with some implementations, the present disclosure allows for obtaining coordinate data of a current location or position of a climber who is in possession or is using a topography recording device and gradient information of the terrain at the current location, and generating a map showing a three-dimensional terrain in the vicinity of the current location in order to inform the climber of the mountain hiking/climbing path terrain (e.g., gradient of the brae).

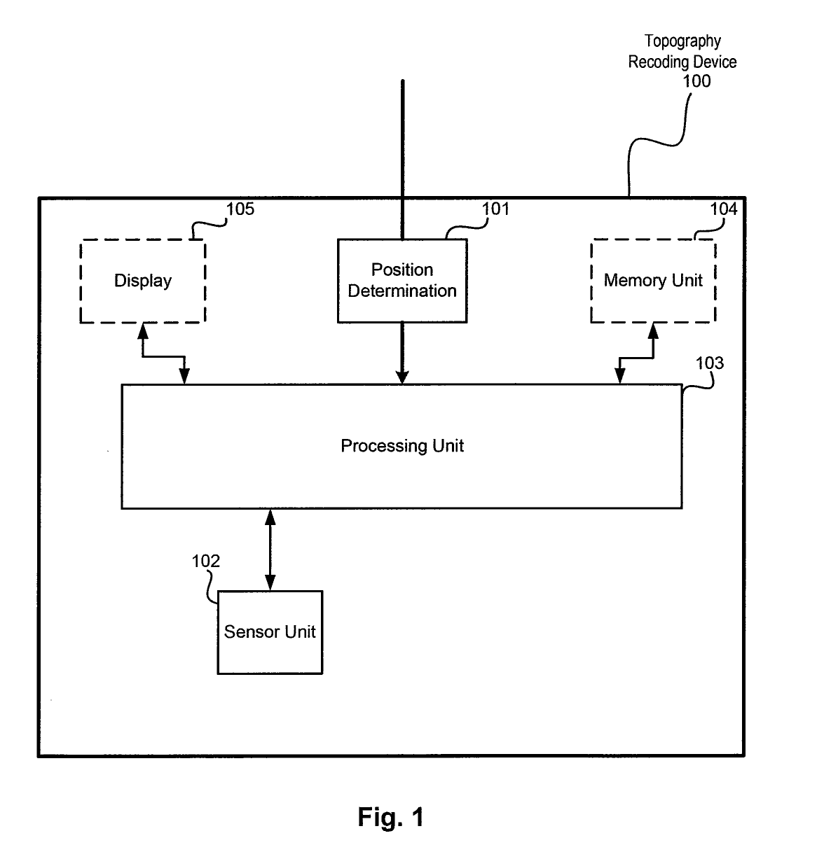

FIG. 1 illustrates a block diagram of a topography recording device 100 according to an illustrative embodiment of the present disclosure. As illustrated by FIG. 1, the topography recording device 100 includes, but is not limited to, a position determination unit 101, a sensor unit 102, and a processing unit 103. The position determination unit 101 and the sensor unit 102 are coupled to the processing unit 103.

In an illustrative embodiment of the present disclosure, the position determination unit 101 determines coordinate data associated with a current location (or position) of the topography recording device 100. The sensor unit 102 determines the inclination of the terrain (e.g., brae) at the location of the topography recording device 100. The position determination unit 101 and the sensor unit 102 may provide the coordinate data and data representing or indicating the inclination of the terrain, respectively, to the processing unit 103, for example, for processing. By way of example, the processing unit 103 may calculate the gradient of the terrain at the location of the topography recording device 100 based on the data representing the inclination of the terrain at the location, and generate a map showing three-dimensional terrain in the vicinity of the location based on the coordinate data and the calculated gradient of the terrain at the location.

Depending on the desired configuration, the position determination unit 101 may be implemented using or include one or more components or modules of any of a variety of conventional GPS systems. By way of example, and not limitation, the position determination unit 101 may be implemented using or include components or modules of conventional and readily available GPS products or modules provided by SiRF (217 Devcon Drive San Jose Calif. 95112, USA), Nemerix (Stabile Gerre 2000, Manno 6928, Switzerland) and Garmin (1200 E. 151st Street, Olathe, Kans. 66062-3426, USA), or any combination thereof. In some configurations, the position determination unit 101 may also include an assisted GPS (A-GPS) module or system to improve the performance of the position determination unit.

The sensor unit 102 may be implemented using or include one or more components or modules of any of a variety of conventional tilt sensors capable of determining or measuring the tilting (that is, orientation or inclination) of the topography recording device 100. In some configurations, the sensor unit 102 may be implemented using or include an accelerometer to provide a measure of the tilt angle (e.g., data representing the inclination or tilt angle) with reference to the earth's ground plane.

Depending on the desired configuration, the processing unit 103 may be of any type of processor including but not limited to a microprocessor (μP), a microcontroller (μC), a digital signal processor (DSP), or any combination thereof.

In operation, the position determination unit 101 receives positioning signals from multiple satellites and, using the received signals, calculates (obtains) coordinate data representing the current location or position of the topography recording device 100. Here, for example, the current location or position may be a particular location or position along a hiking path being currently walked by a climber who is using the topography recording device 100. Stated another way, the current location may indicate the current location of the climber within the hiking path. Generally, the coordinate data of the location of the topography recording device 100 may include, but is not limited to, a latitude, longitude, and altitude of the topography recording device 100, which indicates the precise location of the topography recording device 100. The position determination unit 101 sends the coordinate data representing the current location of the topography recording device 100 to the processing unit 103.

The sensor unit 102 determines the inclination of the terrain (e.g., the inclination of a brae) at the current location of the topography recording device 100. Continuing the above example of the climber using the topography recording device 100, if the terrain at the current location of the climber is not even, i.e., the terrain at the current location has an inclination, the sensor unit 102 is tilted, and the gravity acceleration ‘g’ is constantly divided into two components in two directions due to the unevenness (inclination) of the terrain at the current location. One component of the gravity is parallel to the surface of the terrain, and the other component of gravity is vertical to the surface of the terrain. The inclination of the terrain can be determined with the two components of the gravity acceleration ‘g’.

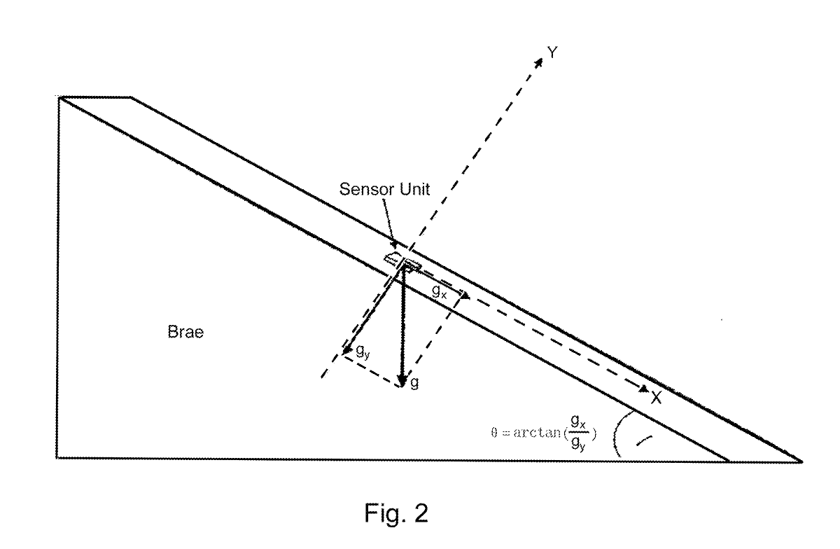

The FIG. 2 shows a schematic view of a technique for determining the inclination of the terrain and calculating the slope gradient of the terrain by the sensor unit 102, according to an illustrative embodiment of the present disclosure. As depicted in FIG. 2, the x-axis refers to the axis that is parallel to the surface of a terrain (e.g., a brae), and the y-axis refers to the axis that is vertical to the surface of the terrain. Moreover, in FIG. 2, ‘g’ refers to the gravity acceleration, ‘gₓ’ refers to the component of the gravity acceleration along the x-axis, and ‘g_{y}’ refers to the component of gravity acceleration along the y-axis.

The sensor unit 102 may determine the inclination of the terrain at the current location. In some embodiments, the sensor unit 102 may measure values of the two components of the gravity acceleration, ‘gₓ’ and ‘g_{y}’, and determine data associated with the two components of the gravity acceleration ‘gₓ’ and ‘g_{y}’ representing the inclination of the terrain at the current location. The sensor unit 102 sends the data representing the inclination of the terrain at the current location to the processing unit 103.

Referring again to FIG. 1, the processing unit 103 may use the data provided by the sensor unit 102 (i.e., the two components of gravity acceleration ‘gₓ’ and ‘g_{y}’ detected by the sensor unit 102) to calculate the angle (slope gradients) θ of the terrain (e.g., brae) at the current location according to the following equation (1):

$$θ = arctan ( \frac{{g}_{x}}{{g}_{y}} ) \qquad ( 1 )$$

Using the position coordinates provided by the position determination unit 101 and the calculated slope gradients, the processing unit 103 may generate a map that shows or indicates the terrain at the current location in three-dimensions. Continuing the above example of the climber using the topography recording device 100, the climber may realize the steepness of the terrain at or proximate to his or her current location from the three-dimensional map of the terrain displayed on or by the topography recording device 100.

In some embodiments, the position determination unit 101 and the sensor unit 102 performs sampling at a relatively high frequency (for example, 50 times per second, or more) to allow the processing unit 103 to generate a map showing the three-dimensional terrain at a location in real-time. The processing unit 103 may periodically adjust the sampling rate of the position determination unit 101 and/or the sensor unit 102. For example, the processing unit 103 may periodically adjust the sampling rate of the position determination unit 101 and/or the sensor unit 102 based on one or more operating parameters of the topography recording device 100, such as, current battery level, current state (e.g., power saving mode, state of its display, etc.), or the like or any combination thereof. The topography recording device 100 may optionally provide an interface (not shown) to facilitate the inputting of a desired sampling rate by, for example, a user of the topography recording device 100.

The topography recording device 100 may have additional features or functionality. For example, the topography recording device 100 may include a memory unit 104 coupled to the processing unit 103. Depending on the desired configuration, the memory unit 104 may be of any type including but not limited to volatile memory (such as RAM), non-volatile memory (such as ROM, flash memory, CF, SD, memory stick etc.) or any combination thereof. The memory unit 104 may store system data and program data for the processing unit 103 to perform predetermined processes (e.g., for controlling the operations of the position determination unit 101 and sensor unit 102). Moreover, the processing unit 103 may establish a database (not shown) in the memory unit 104 to store maps showing the three-dimensional terrain of locations generated by the processing unit 103.

Moreover, the topography recording device 100 may include a display 105 coupled to the processing unit 103. Depending on the desired configuration, the display 105 may be of any type of display panel including but not limited to LCD, LED, or any combination thereof. The display 105 may display any type of data such as image and text based on the data supplied by the processing unit 103. In some embodiments, the processing unit 103 may combine maps showing three-dimensional terrain of each location along the hiking route, which is stored in the memory unit 104, and provide the combined map showing three-dimensional terrain of the whole hiking route to the display 105 to allow the user of the topography recording device 100 to realize the steepness of the hiking path. Moreover, in some embodiments, according to the data supplied by the processing unit 103, the display 105 may display maps which show the slope gradients (steepness) of terrains along different hiking paths, so that the user of the topography recording device 100 can, for example, check an appropriate mountain hiking route or an appropriate route for return.

Next, a topography recording device according to another illustrative embodiment of the present disclosure will be described.

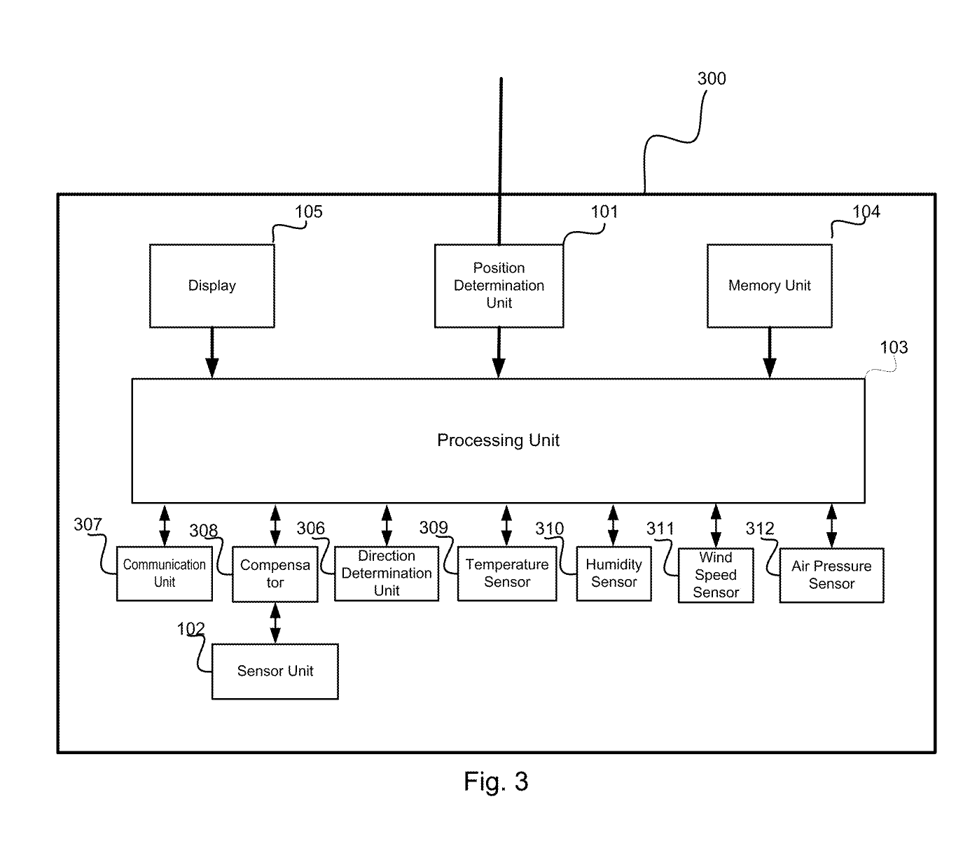

FIG. 3 illustrates a block diagram of a topography recording device 300 according to another illustrative embodiment of the present disclosure. The topography recording device 300 of FIG. 3 is substantially similar to the topography recording device 100 of FIG. 1, with additional details. Those components in FIG. 3 that are labeled identically to components of FIG. 1 will not be described again for clarity purpose. In addition to the components described above in FIG. 1, the topography recording device 300 shown in FIG. 3 may further include at least one of the following units: a direction determination unit 306, a communication unit 307, a compensator 308, a temperature sensor 309, a humidity sensor 310, a wind speed sensor 311, and an air pressure sensor 312.

The direction determination unit 306, communication unit 307, compensator 308, temperature sensor 309, humidity sensor 310, wind speed sensor 311, and air pressure sensor 312 are coupled to the processing unit 103, respectively. The compensator 308 is further coupled to the sensor unit 102.

In an illustrative embodiment of the present disclosure, the direction determination unit 306 determines a direction of the movement of the topography recording device 300. The communication unit 307 transmits data to external devices, or receives data from the external devices. The compensator 308 eliminates the fluctuations from the outputs (i.e., data representing the inclination) of the sensor unit 102, and provides the results to the processing unit 103. The temperature sensor 309 detects temperature in the vicinity of the location of the topography recording device 300. The humidity sensor 310 detects humidity in the vicinity of the location of the topography recording device 300. The wind speed sensor 311 detects a wind speed in the vicinity of the location of the topography recording device 300. The air pressure sensor 312 detects an air pressure in the vicinity of the location of the topography recording device 300.

Depending on the desired configuration, the direction determination unit 306 may be implemented using or include one or more components or modules of any of a variety of conventional geomagnetic sensors.

The communication unit 307 may be implemented using or include any of a variety of connection devices using wired or wireless connection medias such as acoustic, radio frequency (RF), microwave, and infrared (IR), and may share the data stored in the topography recording device 300 with other devices via LAN, WAN, WLAN, or Internet etc.

Depending on the desired configuration, the compensator 308 may be of any type of low pass filter (LPF) including, but not limited to, a mean filter, FIR filter, or any combination thereof.

The temperature sensor 309 may be implemented using or include any of a variety of temperature sensors including thermocouple temperature sensor, resistor temperature sensor, radiation temperature sensor, crystal temperature sensor, or any combination thereof.

The humidity sensor 310 may be implemented using or include any of a variety of humidity sensors including resistor type humidity sensor, capacity type humidity sensor, or any combination thereof.

The wind speed sensor 311 may be implemented using or include any of a variety of wind speed sensors including accelerometer, mechanism wind speed sensor, ultrasonic wind speed sensor, acoustic resonance wind speed sensor, or any combination thereof.

The air pressure sensor 312 may be implemented using or include any of a variety of conventional absolute air pressure sensor, pressure difference sensor, surface pressure sensor, or any combination thereof.

In operation, the direction determination unit 306 detects a movement of the topography recording device 300, obtains the information associated with direction of the movement, and sends the information associated with the direction of the movement to the processing unit 103. In an illustrative example of the present disclosure, the direction determination unit 306 may function as a compass.

The communication unit 307 receives data of other maps showing a three-dimensional terrain of other locations (other hiking route information) from other topography recording devices 300, and transmits the data (maps) received from other topography recording devices 300 to the processing unit 103. In some embodiments of the present disclosure, the maps received from other topography recording devices 300 may be further transmitted to the memory unit 104 by the processing unit 103 for storing. Therefore, with the maps received from other topography recording devices 300, multiple maps may exist in the memory unit 104. The processing unit 103 may perform updating operation based on the received data of other maps to update the database established in the memory unit 104. In some embodiments of the present disclosure, based on the predetermined settings of the topography recording device 300, the display 105 of the topography recording devices 300 may display the map or maps generated by the topography recording devices 300 and the other maps received by the communication unit 307 in combination to provide more options for the user of the topography recording devices 300 for hiking. Furthermore, the display 105 may display a map or maps generated by the topography recording devices 300 and the other maps received by the communication unit 307 separately.

Moreover, the communication unit 307 may transmit maps generated by the processing unit 103 to other topography recording devices 300 to share the maps with other users. With the maps shared with other topography recording devices 300, a user of the topography recording device 300 or other topography recording devices 300 may select an appropriate route for hiking.

The compensator 308 receives the output of the sensor unit 102, that is, the data indicating the inclination of the terrain at the location detected by the sensor unit 102, and eliminates regular fluctuations from the output of the sensor unit 102. As described above according to the FIG. 2, the sensor unit 102 may measure two components of gravity acceleration generated due to the inclination of the terrain (e.g., brae) at the current location. In application, the topography recording device 300 is usually bound to the body of the user (e.g., waist or wrist). The body vibrations due to the movement of the user may cause the changes in the inclination at the location, which causes fluctuations in the data (e.g., the two components of gravity acceleration) detected by the sensor unit 102. Because the body vibrations are usually in vertical direction, and the frequency of the vibrations is relatively high compared to changes in the components of the gravity acceleration caused by the changes in the inclination of the terrain, the fluctuations in the data detected by the sensor unit 102 can be eliminated by the compensator 308, which may be a LPF filter in some embodiments. Therefore, according to an illustrative embodiment of the present disclosure, the compensator 308 such as a low pass filter (LPF) may easily eliminate (filter out) the fluctuations from the data representing the inclination of the terrain at the location, which is detected by the sensor unit 102. The compensator 308 may output the result, that is, the data representing the inclination detected by the sensor unit 102 with the regular fluctuations eliminated, to the processing unit 103. In some embodiments of the present disclosure, parameters of the compensator 308 (e.g., the frequency of the fluctuation that can be eliminated (filtered) by the compensator 308) may be set based on the experience or experiments, and may be set arbitrarily by user through the interface (not shown) provided on the topography recording devices 300.

The temperature sensor 309 detects temperature in the vicinity of the location, and outputs data associated with the detected temperature to the processing unit 103. The humidity sensor 310 detects humidity in the vicinity of the location, and outputs data associated with the detected humidity to the processing unit 103. The wind speed sensor 311 detects a wind speed in the vicinity of the location, and outputs data associated with the detected wind speed to the processing unit 103. The air pressure sensor 312 detects an air pressure in the vicinity of the location, and outputs data associated with the detected air pressure, which may be used to determine a weather forecast, to the processing unit 103. The processing unit 103 receives data associated with the temperature, humidity, wind speed, and air pressure in the vicinity of the location, and generates environmental information associated with the location, such as the temperature, humidity, wind speed, and air pressure in the vicinity of the location. In some embodiments of the present disclosure, the processing unit 103 may associate the environmental information with the map or maps showing the three-dimensional terrain in the database. Therefore, for continuous locations in the hiking path, not only the slope gradients of the terrain at the locations are recorded, but the environmental information such as temperature, humidity, wind speed, and air pressure around the locations are recorded as well. Moreover, the processing unit 103 may instruct the display 105 to display the environmental information of different locations on the map, or to display the environmental information individually, which is necessary for the users to take reference during the mountain hiking.

In some embodiments of the present disclosure, the topography recording device may be implemented as a part of a small-form factor portable (or mobile) electronic device such as a cell phone, a personal data assistant (PDA), a personal media player device, a personal headset device, an application specific device, or a hybrid device that implements any of the above functions, which can be easily carried by the user who is using the topography recording device. In some embodiments, the topography recording device may also be incorporated into a personal computer including a laptop computer.

Next a method for recording topography according to an illustrative embodiment of the present disclosure will be described in detail.

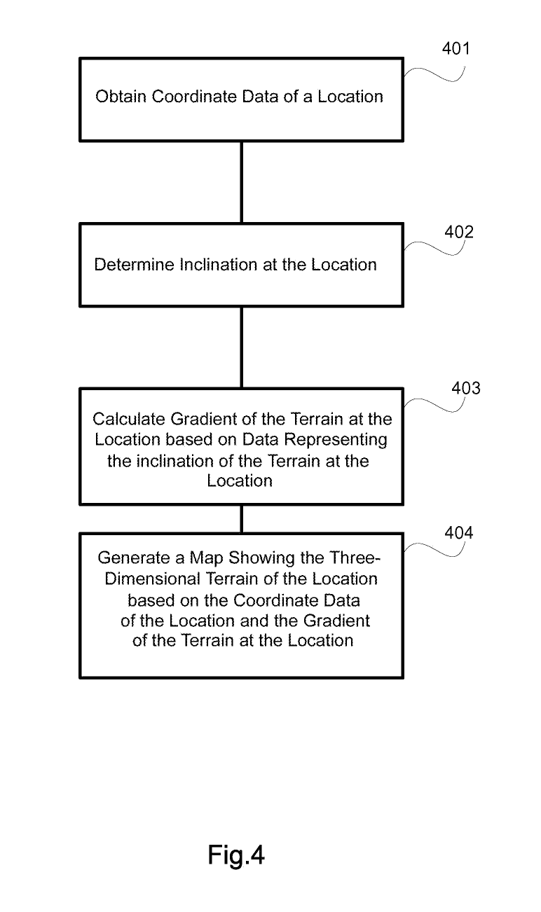

FIG. 4 shows a process for recording topography data according to an illustrative embodiment of the present disclosure. The process may include one or more functions, operations, or actions as depicted by blocks 401, 402, 403 and/or 404. In some implementations, the various features of the illustrated blocks for the process may be combined into fewer blocks, divided into additional blocks, or eliminated based on the desired result.

Processing for the process may begin at block 401, “Obtain Coordinate Data of a Location”. Block 401 may be followed by block 402, “Determine Inclination at the Location”. Block 402 may be followed by block 403, “Calculate Gradient of the Terrain at the Location based on Data Representing the inclination of the Terrain at the Location”. Block 403 may be followed by block 404, “Generate a Map indicating the Three-Dimensional Terrain of the Location based on the Coordinate Data of the Location and the Gradient of the Terrain at the Location”.

At block 401, coordinate data of a location is obtained. Here, multiple positioning signals from satellites are received so that the location coordinates are recorded. The coordinate data of the location are, for example, a latitude, longitude, and altitude indicating the precise location.

At block 402, inclination of the terrain at the location is determined. In some embodiments, two components of gravity acceleration ‘gₓ’ and ‘g_{y}’, which indicate the inclination of the terrain, at the location due to the inclination are measured.

At block 403, the slope gradient of the terrain at the location is calculated based on the data which represents the inclination of the terrain at the location (e.g., the components of gravity acceleration). In some embodiments, the slope gradient (the angle θ of the inclination) of the terrain is calculated according to the equation (1) described above.

At block 404, based on the coordinate data of the location (e.g., at least one of the latitude, longitude, and altitude) and the data representing the inclination of the terrain, a map showing three-dimensional terrain of the location is generated.

In accordance with an illustrative embodiment, the above described process can be realized by the topography recording device 100 or 300. In some embodiments, the operations of block 401 can be performed by the location determination unit 101 of FIG. 1 or FIG. 3, in which the location determination unit 101 obtains data indicating a location of the topography recording device 100 or 300, which includes at least one of the latitude, longitude, and altitude. The operations of block 402 can be performed by the sensor unit 102, in which the sensor unit 102 determines the inclination of the terrain at the location. The operations of block 403 can be performed by the processing unit 103, in which the processing unit 103 calculates the slope gradient of the terrain at the location based on the data representing the inclination of the terrain determined by the sensor unit 102. The operations of block 404 can be performed by the processing unit 103, in which the processing unit 103 generates a map showing three-dimensional terrain of the location based on the coordinate data of the location (e.g., at least one of the latitude, longitude, and altitude) and the slope gradient of the terrain at the location.

In accordance with another illustrative embodiment, the topography recording process of FIG. 4 may further share the map showing the three-dimensional terrain of the location with external devices. For example, in one example implementation, the communication unit 307 may receive other maps showing the three-dimensional terrain of other locations from other topography recording devices 300, and the received maps may be used for updating the database which stores the maps. Moreover, the communication unit 307 may transmit the maps stored in the database to other topography recording devices 300, so that the maps are shared with other topography recording devices 300.

Moreover, the topography recording process of FIG. 4 may further display the map showing the three-dimensional terrain of the location and the map received from other topography recording devices in combination or individually. This may be performed by the processing unit 103 and display 105. In some embodiments of the present disclosure, the processing unit 103 may combine the map generated by the topography recording device and maps received from other topography recording devices, and instruct the display 105 to display the combined map based on the setting of the topography recording device. In some embodiments, the processing unit 103 may select one map from the maps stored in the database and instruct the display 105 to display the selected map.

In accordance with another illustrative embodiment, the topography recording process of FIG. 4 may further eliminate fluctuations from the data representing inclination of the terrain at the location and output the result (data with fluctuation eliminated). For example, in one example implementation, the compensator 308 may eliminate fluctuations from the data detected by the sensor unit 102, and output the result with fluctuation eliminated to the processing unit 103, as the data indicating the inclination of terrain at the location.

In accordance with another illustrative embodiment, the topography recording process of FIG. 4 may further include any one of the following operations: detect a temperature in the vicinity of the location; detect humidity in the vicinity of the location; detect wind speed in the vicinity of the location; detect an air pressure in the vicinity of the location; or generate environmental parameters associated with the map showing the three-dimensional terrain of the location based on at least one of the temperature, humidity, wind speed, and air pressure detected at each possible location. The above operations can be performed by the temperature sensor 309, humidity sensor 310, wind speed sensor 311, air pressure sensor 312, and processing unit 103, respectively. In some embodiments of the present disclosure, the temperature sensor 309 detects temperature in the vicinity of the location of the topography recording device 300, the humidity sensor 310 detects humidity in the vicinity of the location of the topography recording device 300, the wind speed sensor 311 detects a wind speed in the vicinity of the location of the topography recording device 300, the air pressure sensor 312 detects an air pressure in the vicinity of the location of the topography recording device 300, and the processing unit 103 generates environmental information around the location based on at least one of the detected temperature, humidity, wind speed, and air pressure and associates the environmental information with the three-dimensional map or maps in the database.

Moreover, the topography recording process of FIG. 4 may further display at least one of the map and the environmental parameters associated with the location. For example, in one example implementation, the display 105 may display the environmental information of different locations of the hiking path with the three-dimensional map, or display the environmental information individually.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those skilled within the art that each function and/or operation within such block diagrams, flowcharts, embodiments, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more programs running on one or more information processing apparatus, as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium storing programs for executing the topography method according to the embodiments of the present disclosure may include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing devices or apparatus. That is, at least a portion of the devices and/or processes described herein may be integrated into a data processing device or apparatus via a reasonable amount of experimentation. Those having skill in the art will recognize that a typical data processing device generally includes one or more of a device housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control mechanism including feedback loops and control motors (e.g., feedback for sensing location and/or velocity; control motors for moving and/or adjusting components and/or quantities). A typical data processing device may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A topography recording device comprising:
a position determination unit configured to obtain coordinate data of a location;
a sensor unit configured to determine inclination of the terrain at the location;
a processing unit coupled to the position determination unit and the sensor unit, and configured to calculate gradient of the terrain at the location based on data representing the inclination of terrain at the location, and to generate a map showing three-dimensional terrain in the vicinity of the location based on the coordinate data of the location and the gradient of the terrain at the location.

2. The topography recording device of claim 1, wherein the coordinate data indicates at least one of a longitude, latitude, and altitude of the location.

3. The topography recording device of claim 1, wherein the sensor unit comprises an accelerometer, and the data representing the inclination of terrain at the location comprises at least two components of acceleration of gravity at the location.

4. The topography recording device of claim 1, further comprising:
a compensator coupled to the sensor unit and the processing unit, and configured to eliminate regular fluctuations from the data representing the inclination, and to provide the results to the processing unit.

5. The topography recording device of claim 1, further comprising at least one of:
a temperature sensor coupled to the processing unit, and configured to detect temperature in the vicinity of the location;
a humidity sensor coupled to the processing unit, and configured to detect humidity in the vicinity of the location;
a wind speed sensor coupled to the processing unit, and configured to detect wind speed in the vicinity of the location;
an air pressure sensor coupled to the processing unit, and configured to detect air pressure in the vicinity of the location,
wherein the processing unit generates environmental parameters associated with the location based on at least one of the temperature, humidity, wind speed, and air pressure.

6. The topography recording device of claim 5, further comprising:
a display unit configured to display at least one of the map and the environmental parameters associated with the location.

7. The topography recording device of claim 1, further comprising:
a communication unit configured to transfer data of the map showing the three-dimensional terrain of the location to another device.

8. The topography recording device of claim 1, further comprising:
a communication unit configured to receive from another device data of another map showing the three-dimensional terrain of another location.

9. The topography recording device of claim 8, wherein the display unit is configured to display the map showing the three-dimensional terrain of the location and the other map showing the three-dimensional terrain of the other location jointly.

10. The topography recording device of claim 8, wherein the display unit is configured to display the map showing the three-dimensional terrain of the location and the other map showing the three-dimensional terrain of the other location individually.

11. The topography recording device of claim 1, wherein the location comprises a plurality of continuous locations of a hiking path.

12. A topography recording method comprising:
obtaining coordinate data of a location;
determining inclination of the terrain at the location;
calculating gradient of the terrain at the location based on data representing inclination of the terrain at the location; and
generating a map showing three-dimensional terrain of the location based on the coordinate data of the location and the gradient of the terrain at the location.

13. The topography recording method of claim 12, further comprising:
eliminating regular fluctuations from the data representing the inclination of terrain at the location.

14. The topography recording method of claim 12, further comprising:
detecting temperature in the vicinity of the location;
detecting humidity in the vicinity of the location;
detecting wind speed in the vicinity of the location;
detecting air pressure in the vicinity of the location; and
generating environmental parameters associated with the location based on at least one of the temperature, humidity, wind speed, and air pressure.

15. The topography recording method of claim 14, further comprising:
displaying on a screen at least one of the map and the environmental parameters associated with the location.

16. The topography recording method of claim 12, further comprising:
outputting data of the map showing the three-dimensional terrain of the location.

17. The topography recording method of claim 12, further comprising:
receiving data of another map showing the three-dimensional terrain of another location.

18. The topography recording method of claim 17, further comprising:
displaying on a screen the map showing the three-dimensional terrain of the location and the other map showing the three-dimensional terrain of the other location jointly.

19. The topography recording method of claim 17, further comprising:
displaying on a screen the map showing the three-dimensional terrain of the location and the other map showing the three-dimensional terrain of the other location individually.

20. A computer-readable recording medium containing a set of instructions that, when executed by a processor, causes the processor to perform a method comprising:
obtaining coordinate data of a location;
determining inclination of terrain at the location;
calculating gradient of the terrain at the location based on data representing the inclination of terrain at the location; and
displaying on a screen a map showing three-dimensional terrain of the location based on the coordinate data of the location and the gradient of the terrain at the location.
